(19) United States
(12) Patent Application Publication
(10) Pub. No.: US 2025/0364824 A1
(43) Pub. Date: Nov. 27, 2025

(54) HYBRID SUPERCAPACITORS IN POWER TOOL DEVICES

(71) Applicant: MILWAUKEE ELECTRIC TOOL CORPORATION, Brookfield, WI (US)

(72) Inventors: Chun Jian Tang, West Allis, WI (US); Kyle J. Radovich, West Bend, WI (US); Michael A. Barrowclift, East Troy, WI (US); Samantha L. Billetdeaux, New Berlin, WI (US)

(21) Appl. No.: 18/867,248

(22) PCT Filed: May 31, 2023
(86) PCT No.: PCT/US2023/024022

§ 371 Date: Nov. 19, 2024

Related U.S. Application Data
(60) Provisional application No. 63/347,837, filed on Jun. 1, 2022.

(51) Int. Cl. H02J 7/00; H02J 7/34

(52) U.S. Cl. CPC H02J 7/0068; H02J 7/00712; H02J 7/345; H02J 2207/50

(57) ABSTRACT

Systems and methods for implementing a hybrid supercapacitor within power tool devices. One device includes a primary power source, a hybrid supercapacitor, and a controller. The controller is selectively coupled to the primary power source and the hybrid supercapacitor. The controller is configured to receive power from the primary power source and to determine a voltage of the primary power source. The controller is configured to determine whether the voltage of the primary power source is less than or equal to a voltage threshold and connect, in response to the voltage of the primary power source being less than or equal to the voltage threshold, the hybrid supercapacitor to the controller.

### RELATED APPLICATIONS

This application claims the benefit of U.S. Provisional Patent Application No. 63/347,837, filed Jun. 1, 2022, the entire content of which is hereby incorporated by reference.

### SUMMARY

Embodiments described herein provide systems and methods for implementing a hybrid supercapacitor within power tools devices.

Devices described herein include a primary power source, a hybrid supercapacitor, and a controller. The controller is selectively coupled to the primary power source and the hybrid supercapacitor. The controller is configured to receive power from the primary power source and to determine a voltage of the primary power source. The controller is configured to determine whether the voltage of the primary power source is less than or equal to a voltage threshold and connect, in response to the voltage of the primary power source being less than or equal to the voltage threshold, the hybrid supercapacitor to the controller.

In some aspects, the device further includes a recharge circuit configured to charge the hybrid supercapacitor using the primary power source.

In some aspects, the controller is further configured to provide power from the hybrid supercapacitor to an insertable wireless communication device connected to the controller.

In some aspects, the controller is further configured to disconnect, in response to the voltage of the primary power source being less than or equal to the voltage threshold, the primary power source from the controller.

In some aspects, the controller is further configured to determine whether the voltage of the primary power source is greater than or equal to a second voltage threshold, and disconnect, in response to the voltage of the primary power source being greater than or equal to the second voltage threshold, the hybrid supercapacitor.

In some aspects, the hybrid supercapacitor includes a plurality of hybrid supercapacitors connected in series.

In some aspects, the controller is further configured to determine whether a low-power operating mode is initiated, connect, in response to the low-power operating mode being initiated, the hybrid supercapacitor to the controller, and disconnect, in response to the low-power operating mode being initiated, the primary power source from the controller.

In some aspects, the device is one selected from a group consisting of a power tool, a power tool battery pack, a battery pack charger, a power inverter, and a portable power supply device.

In some aspects, the device is one selected from a group consisting of a light device, a heating device, an outdoor power equipment device, and vacuum.

In some aspects, the primary power source is at least one battery cell.

In some aspects, the primary power source is a power supply battery core.

Methods described herein for selecting a discharging source include receiving, with a discharge load, power from a primary power source, and determining, with the controller, a voltage of the primary power source. The method includes determining, with the controller, whether the voltage of the primary power source is less than or equal to a voltage threshold, and connecting, with the controller and in response to the voltage of the primary power source being less than or equal to the voltage threshold, a hybrid supercapacitor to the discharge load.

In some aspects, the method further includes charging, with a recharge circuit, the hybrid supercapacitor using the primary power source.

In some aspects, the method further includes providing, with the controller, the power from the hybrid supercapacitor to an insertable wireless communication device connected to the controller.

In some aspects, the method further includes disconnecting, with the controller and in response to the voltage of the primary power source being less than or equal to the voltage threshold, the primary power source from the discharge load.

In some aspects, the method further includes determining, with the controller, whether the voltage of the primary power source is greater than or equal to a second voltage threshold, and disconnecting, with the controller and in response to the voltage of the primary power source being greater than or equal to the second voltage threshold, the hybrid supercapacitor.

In some aspects, the method further includes determining, with the controller, whether a low-power operating mode has been initiated, connecting, with the controller and in response to the low-power operating mode being initiated, the hybrid supercapacitor to the discharge load, and disconnecting, with the controller and in response to the low-power operating mode being initiated, the primary power source from the discharge load.

Devices described herein include a primary power source, a hybrid supercapacitor, an insertable wireless communication device, and a controller. The controller is selectively coupled to the primary power source and the hybrid supercapacitor. The controller is configured to provide power from the primary power source to the insertable wireless communication device. The controller is configured to determine a voltage of the primary power source and determine whether the voltage of the primary power source is less than or equal to a voltage threshold. The controller is configured to provide, in response to the voltage of the primary power source being less than or equal to the voltage threshold, power from the hybrid supercapacitor to the insertable wireless communication device.

In some aspects, the controller is further configured to determine whether the voltage of the primary power source is greater than or equal to a second voltage threshold, and provide, in response to the voltage of the primary power source being greater than or equal to the second voltage threshold, power from the primary power source to the insertable wireless communication device.

In some aspects, the controller is further configured to determine whether a low-power operating mode is initiated, and provide, in response to the low-power operating mode being initiated, power from the hybrid supercapacitor to the insertable wireless communication device.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other features and aspects will become apparent by consideration of the following detailed description and accompanying drawings.

### BRIEF DESCRIPTION OF THE DRAWINGS

FIG. 1 illustrates a power tool in accordance with embodiments described herein.

FIG. 2 illustrates a block diagram of a controller for the power tool of FIG. 1 in accordance with embodiments described herein.

FIG. 3 illustrates a perspective view of an insertable wireless communication device within the power tool of FIG. 1 in accordance with embodiments described herein.

FIG. 4 illustrates a perspective view of the insertable wireless communication device of FIG. 3 electrically and physically coupled to a printed circuit board in accordance with embodiments described herein.

FIG. 5 illustrates a perspective view of the insertable wireless communication device of FIG. 3 decoupled from the printed circuit board of FIG. 4 in accordance with embodiments described herein.

FIG. 6 illustrates a perspective view of the printed circuit board of FIG. 4 and a connector in accordance with embodiments described herein.

FIG. 7 illustrates a power tool battery pack in accordance with embodiments described herein.

FIG. 8 illustrates a block diagram of a controller for the battery pack of FIG. 3 in accordance with embodiments described herein.

FIG. 9 illustrates a power tool charger in accordance with embodiments described herein.

FIG. 10 illustrates a block diagram of a controller for the power tool charger of FIG. 9 in accordance with embodiments described herein.

FIG. 11 illustrates a power supply in accordance with embodiments described herein.

FIG. 12 illustrates a block diagram of a wireless communication controller in accordance with embodiments described herein.

FIG. 13 illustrates a communication system for the power tool of FIG. 1, the battery pack of FIG. 7, the charger of FIG. 9, and the power supply of FIG. 11 in accordance with embodiments described herein.

FIG. 14 illustrates a discharge cycle of an example lithium-ion power source in accordance with embodiments described herein.

FIG. 15 illustrates a discharge cycle of an example supercapacitor in accordance with embodiments described herein.

FIG. 16 illustrates a discharge cycle of an example hybrid supercapacitor in accordance with embodiments described herein.

FIG. 17 illustrates a block diagram of circuitry for selecting between a primary power source and a hybrid supercapacitor in accordance with embodiments described herein.

FIG. 18 illustrates another block diagram of circuitry for selecting between a primary power source and a hybrid supercapacitor in accordance with embodiments described herein.

FIG. 19 illustrates a flow chart of a method for selecting between discharging sources in accordance with embodiments described herein.

FIG. 20 illustrates a flow chart of another method for selecting between discharging sources in accordance with embodiments described herein.

FIG. 21 illustrates a flow chart of a method for selecting a discharge source based on a low-power operating mode in accordance with embodiments described herein.

FIG. 22 illustrates a flow chart of a method for selecting a discharge source upon exiting a low-power operating mode in accordance with embodiments described herein.

### DETAILED DESCRIPTION

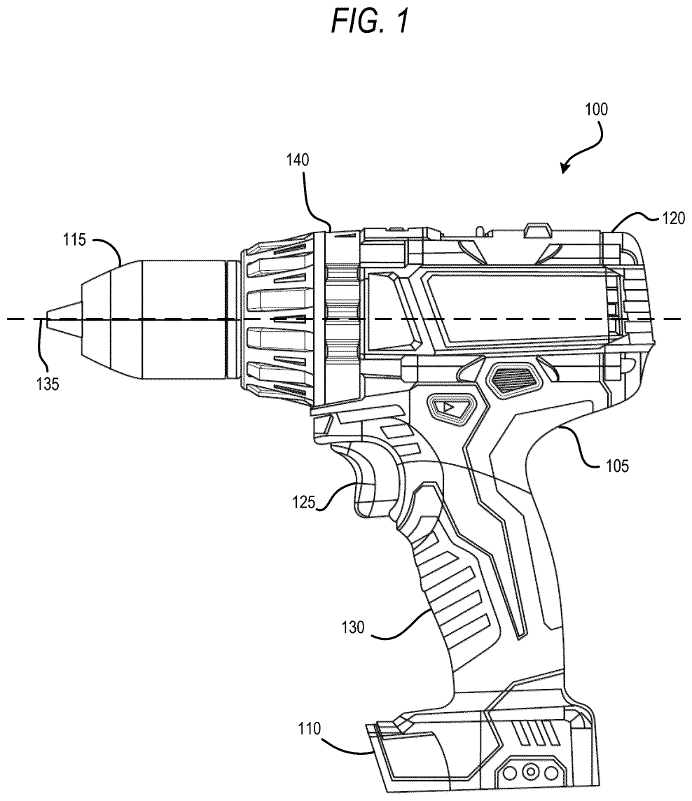

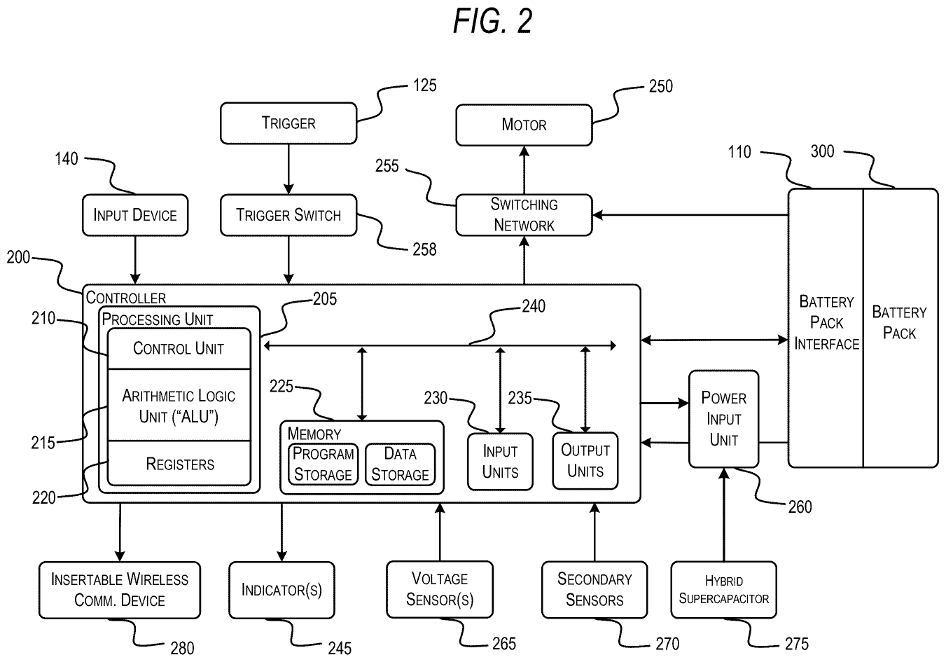

FIG. 1 illustrates an example power tool 100 including a hybrid supercapacitor, according to some embodiments. The power tool 100 includes a housing 105, a battery pack interface 110, a driver 115 (e.g., a chuck or bit holder), a motor housing 120, a trigger 125, a handle 130, and an input device 140. The motor housing 120 houses a motor 250 (see FIG. 2). A longitudinal axis 135 extends from the driver 115 through a rear of the motor housing 120. During operation, the driver 115 rotates about the longitudinal axis 135. The longitudinal axis 135 may be approximately perpendicular with the handle 130. While FIG. 1 illustrates a specific power tool 100 with a rotational output, it is contemplated that the hybrid supercapacitor described herein may be used with multiple types of power tools, such as drills, drivers, powered screw drivers, powered ratchets, grinders, right angle drills, rotary hammers, pipe threaders, or another type of power tool that experiences rotation about an axis (e.g., longitudinal axis 135). In some embodiments, the power tool 100 is a power tool that experiences translational movement along the longitudinal axis 135, such as reciprocal saws, chainsaws, pole-saws, circular saws, cut-off saws, die-grinder, and table saws.

A power tool controller 200 for the power tool 100 is illustrated in FIG. 2. The power tool controller 200 is electrically and/or communicatively connected to a variety of modules or components of the power tool 100. For example, the illustrated power tool controller 200 is connected to indicators 245, voltage sensors 265, secondary sensor(s) 270 (e.g., a current sensor, a temperature sensor, a speed sensor, etc.), the trigger 125 (via a trigger switch 258), a power switching network 255, a power input unit 260, and an insertable wireless communication device 280.

The power tool controller 200 includes a plurality of electrical and electronic components that provide power, operational control, and protection to the components and modules within the power tool controller 200 and/or power tool 100. For example, the power tool controller 200 includes, among other things, a processing unit 205 (e.g., a microprocessor, an electronic processor, an electronic controller, a microcontroller, or another suitable programmable device), a memory 225, input units 230, and output units 235. The processing unit 205 includes, among other things, a control unit 210, an arithmetic logic unit (“ALU”) 215, and a plurality of registers 220 (shown as a group of registers in FIG. 2), and is implemented using a known computer architecture (e.g., a modified Harvard architecture, a von Neumann architecture, etc.). The processing unit 205, the memory 225, the input units 230, and the output units 235, as well as the various modules connected to the power tool controller 200 are connected by one or more control and/or data buses (e.g., common bus 240). The control and/or data buses are shown generally in FIG. 2 for illustrative purposes. The use of one or more control and/or data buses for the interconnection between and communication among the various modules and components would be known to a person skilled in the art in view of the embodiments described herein.

The memory 225 is a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 205 is connected to the memory 225 and executes software instructions that are capable of being stored in a RAM of the memory 225 (e.g., during execution), a ROM of the memory 225 (e.g., on a generally permanent basis), or another non-transitory computer readable medium such as another memory or a disc. Software included in the implementation of the power tool 100 can be stored in the memory 225 of the power tool controller 200. The software includes, for example, firmware, one or more applications, program data, filters, rules, one or more program modules, and other executable instructions. The power tool controller 200 is configured to retrieve from the memory 225 and execute, among other things, instructions related to the control processes and methods described herein. In other embodiments, the power tool controller 200 includes additional, fewer, or different components.

The power tool controller 200 drives the motor 250 to rotate the driver 115 in response to a user's actuation of the trigger 125. The driver 115 may be coupled to the motor 250 via an output shaft. Depression of the trigger 125 actuates a trigger switch 258, which outputs a signal to the power tool controller 200 to drive the motor 250, and therefore the driver 115. In some embodiments, the power tool controller 200 controls the power switching network 255 (e.g., a FET switching bridge) to drive the motor 250. For example, the power switching network 255 may include a plurality of high side switching elements (e.g., FETs) and a plurality of low side switching elements. The power tool controller 200 may control each FET of the plurality of high side switching elements and the plurality of low side switching elements to drive each phase of the motor 250. For example, the power switching network 255 may be controlled to more quickly deaccelerate the motor 250.

The indicators 245 are also connected to the power tool controller 200 and receive control signals from the power tool controller 200 to turn on and off or otherwise convey information based on different states of the power tool 100. The indicators 245 include, for example, one or more light-emitting diodes (LEDs), or a display screen. The indicators 245 can be configured to display conditions of, or information associated with, the power tool 100. For example, the indicators 245 can display information relating to an operational state of the power tool 100, such as a mode or speed setting. The indicators 245 may also display information relating to a fault condition, or other abnormality of the power tool 100. In addition to or in place of visual indicators, the indicators 245 may also include a speaker or a tactile feedback mechanism to convey information to a user through audible or tactile outputs. In some embodiments, the indicators 245 display information relating to whether or not a hybrid supercapacitor 275 is charging or discharging.

The battery pack interface 110 is connected to the power tool controller 200 and is configured to couple with a battery pack 300. The battery pack interface 110 includes a combination of mechanical (e.g., a battery pack receiving portion) and electrical components configured to and operable for interfacing (e.g., mechanically, electrically, and communicatively connecting) the power tool 100 with the battery pack 300. The battery pack interface 110 is coupled to the power input unit 260. The battery pack interface 110 transmits the power received from the battery pack 150 to the power input unit 260. The power input unit 260 includes active and/or passive components (e.g., voltage step-down controllers, voltage converters, rectifiers, filters, etc.) to regulate or control the power received through the battery pack interface 110 and to the power tool controller 200. In some embodiments, the battery pack interface 110 is also coupled to the power switching network 255. The operation of the power switching network 255, as controlled by the power tool controller 200, determines how power is supplied to the motor 250.

The input device 140 is operably coupled to the power tool controller 200 to, for example, select a forward mode of operation, a reverse mode of operation, a torque setting for the power tool 100, and/or a speed setting for the power tool 100 (e.g., using torque and/or speed switches), etc. In some embodiments, the input device 140 includes a combination of digital and analog input or output devices required to achieve a desired level of operation for the power tool 100, such as one or more knobs, one or more dials, one or more switches, one or more buttons, etc. In other embodiments, the input device 140 is configured as a ring (e.g., a torque ring). Movement of the input device 140 sets a desired torque and/or desired a speed value at which to drive the motor 250.

The voltage sensor(s) 265 are configured to monitor a charge voltage of the hybrid supercapacitor 275, a voltage of the motor 250, a voltage of the battery pack 300, and the like. The secondary sensor(s) 270 may include current sensors, speed sensors, temperature sensors, torque sensors, motion sensors, and the like, to detect additional conditions of the power tool 100.

The power input unit 260 also controls whether the power tool controller 200 receives power from the battery pack 300 or from the hybrid supercapacitor 275 (e.g., hybrid power source). For example, as described in more detail below, the power tool controller 200 may control the power input unit 260 to switch power input from the battery pack 300 to the hybrid supercapacitor 275, or vice versa, based on a charge voltage of the battery pack 300. The power tool controller 200 may be powered by the hybrid supercapacitor 275 when a battery pack 300 is not connected to the power tool 100. In some embodiments, the power tool controller 200 is powered by the hybrid supercapacitor 275 when the power tool 100 is a low-power operating mode, such as a shipping mode, a sleep mode, or the like. In some embodiments, the power tool 100 includes a plurality of hybrid supercapacitors 275.

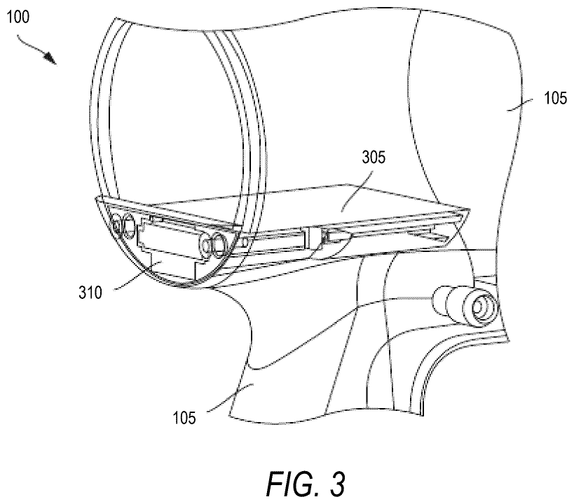

In some instances, an insertable wireless communication device 280 is inserted into (or otherwise coupled to) the power tool 100. As shown in FIG. 3, the housing 105 may include a compartment 305 located above the trigger 125. The compartment 305 may be covered and sealed by a cover 310. In some embodiments, the compartment 305 has a length that runs approximately parallel with the longitudinal axis 135 (e.g., see FIG. 1). In some embodiments, the compartment 305 is a separate assembly component that is isolated from the handle 130 and trigger 125. In some embodiments, the compartment 305 may include damping features to reduce vibration experienced by one or more components located within the compartment 305 (e.g., the insertable wireless communication device 280 described below).

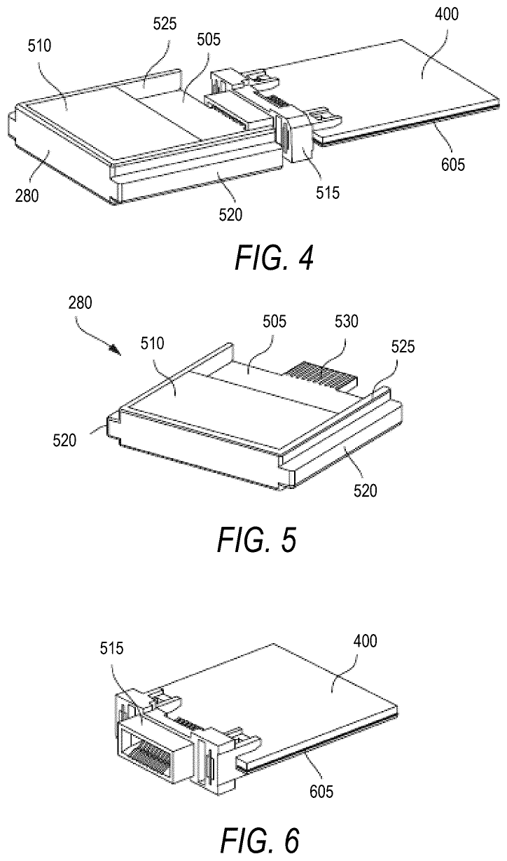

FIG. 4 is a perspective view of the insertable wireless communication device 280 electrically and physically coupled to a first printed circuit board (PCB) 400. As shown in FIG. 4, the insertable wireless communication device 280 includes a second PCB 505 (e.g., an insertable device PCB) within the housing 525 of the insertable wireless communication device 280. In some embodiments, an antenna area 510 of the second PCB 505 is reserved for an antenna.

FIG. 5 is a perspective view of the insertable wireless communication device 280 decoupled from the first PCB 400. As shown in FIG. 4, the second PCB 505 of the insertable wireless communication device 280 includes a second connector 530 (i.e., an insertable device connector) configured to electrically and physically couple to the first connector 515 of the first PCB 400.

FIG. 6 is a perspective view of the first PCB 400 and the first connector 515. As shown in FIG. 6, the first PCB 400 may include a conductive layer 605 (e.g., a layer of copper) that extends throughout a surface area of the first PCB 400. In some embodiments, the first PCB 400 may have multiple such conductive layers sandwiched between the top and bottom surfaces of the first PCB 400. Additionally, in some embodiments, the second PCB 505 of the insertable wireless communication device 280 may include one or more conductive layers similar to the conductive layer 605 of the first PCB 400. Although the first connector 515 and the second connector 530 are illustrated as female and male connectors, respectively, in some embodiments, the first connector 515 is a male connector and the second connector 530 is a female connector, or other types of connectors are used. In some embodiments, the connectors 515 and 530 may not be included. In such embodiments, a component of the first PCB 400 may be configured to wirelessly communicate with a component of the second PCB 505 when the insertable wireless communication device 280 is inserted into the compartment 305. For example, such wireless communication may occur via transceivers/antennas configured to communicate via Bluetooth®, near-field communication, and/or the like.

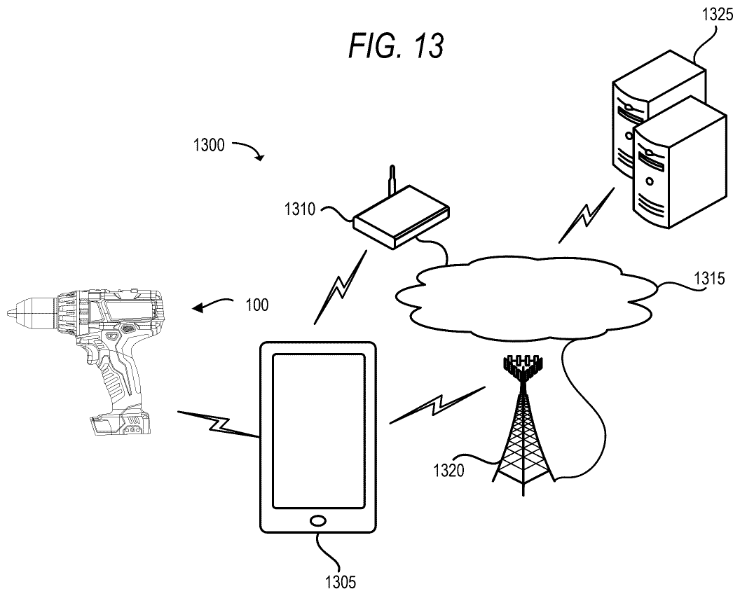

As mentioned previously herein, the compartment 305 allows the insertable wireless communication device 280 to be optionally added to the power tool 100 or any other device as an accessory after manufacturing of the power tool 100 or other device. When the insertable wireless communication device 280 is inserted into the compartment 305, the power tool 100 may wirelessly communicate with other devices connected to a network shared by the insertable wireless communication device 280, such as network 1315 (see, e.g., FIG. 13). In some embodiments, the power tool 100 may not be able to communicate (e.g., wirelessly) with other devices unless the insertable wireless communication device 280 is inserted into the compartment 305. In other embodiments, the power tool 100 may be configured to wirelessly communicate with other devices using a first communication protocol (e.g., a short-range radio communication such as Bluetooth®) when the insertable wireless communication device 280 is not inserted into the compartment 305. In such embodiments, when inserted into the compartment 305, the insertable wireless communication device 280 may additionally or alternatively allow the power tool 100 to communicate wirelessly with other devices using a second communication protocol different than the first communication protocol (e.g., long-range radio communication such as cellular communication over a cellular network). Accordingly, the insertable wireless communication device 280 is configured to expand the communication capabilities of the power tool 100. In some embodiments, the insertable wireless communication device 280 includes the hybrid supercapacitor 275.

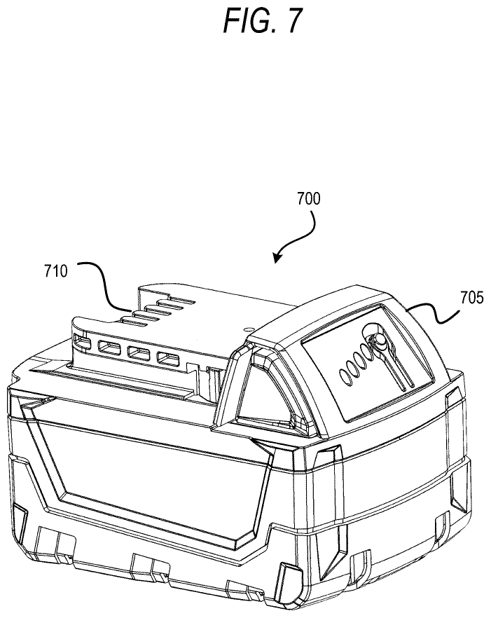

FIG. 7 illustrates the battery pack 700 according to some embodiments. The battery pack 700 includes a battery pack housing 705 and a power tool interface 710. The power tool interface 710 is configured to couple the battery pack 700 to a power tool device, such as the power tool 100. The battery pack 700 provides the power tool 100 with power using the power tool interface 710.

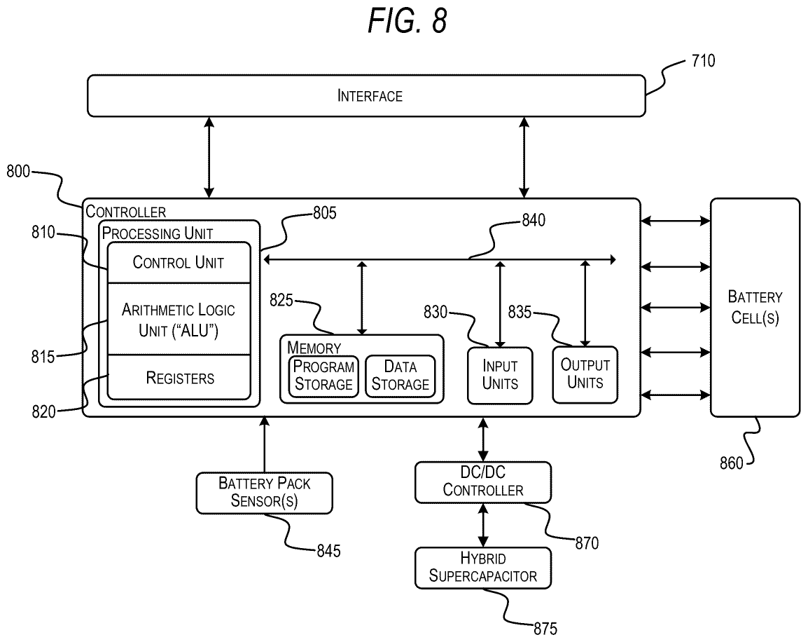

A battery pack controller 800 for the battery pack 700 is illustrated in FIG. 8. The battery pack controller 800 is electrically and/or communicatively connected to a variety of modules or components of the battery pack 700. For example, the illustrated battery pack controller 800 is connected to one or more battery pack sensors 845, a hybrid supercapacitor 875 (via a DC/DC controller 870), one or more battery cell(s) 860, and the power tool interface 710.

The battery pack controller 800 includes a plurality of electrical and electronic components that provide power, operational control, and protection to the components and modules within the battery pack controller 800 and/or battery pack 700. For example, the battery pack controller 800 includes, among other things, a processing unit 805 (e.g., a microprocessor, an electronic processor, an electronic controller, a microcontroller, or another suitable programmable device), a memory 825, input units 830, and output units 835. The processing unit 805 includes, among other things, a control unit 810, an arithmetic logic unit (“ALU”) 815, and a plurality of registers 820 (shown as a group of registers in FIG. 8), and is implemented using a known computer architecture (e.g., a modified Harvard architecture, a von Neumann architecture, etc.). The processing unit 805, the memory 825, the input units 830, and the output units 835, as well as the various modules connected to the battery pack controller 800 are connected by one or more control and/or data buses (e.g., common bus 840). The control and/or data buses are shown generally in FIG. 8 for illustrative purposes. The use of one or more control and/or data buses for the interconnection between and communication among the various modules and components would be known to a person skilled in the art in view of the embodiments described herein.

The memory 825 is a non-transitory computer-readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 805 is connected to the memory 825 and executes software instruction that are capable of being stored in a RAM of the memory 825 (e.g., during execution), a ROM of the memory 825 (e.g., on a generally permanent basis), or another non-transitory computer-readable medium such as another memory or a disc. Software included in the implementation of the battery pack 700 can be stored in the memory 825 of the battery pack controller 800. The software includes, for example, firmware, one or more applications, program data, filters, rules, one or more program modules, and other executable instructions. The battery pack controller 800 is configured to retrieve from the memory 825 and execute, among other things, instructions related to the control processes and methods described herein. In other embodiments, the battery pack controller 800 includes additional, fewer, or different components.

In some embodiments, the battery pack controller 800 is powered by the one or more battery cell(s) 860, and provides power (e.g., current and voltage) to the power tool interface 710 using the one or more battery cell(s) 860. The battery pack sensor(s) 845 are configured to monitor charge voltage, charge current, discharge voltage, and discharge current of the one or more battery cell(s) 860.

In some embodiments, the battery pack controller 800 is instead powered by the hybrid supercapacitor 875. A DC/DC controller 870 controls discharging of the hybrid supercapacitor 875 to ensure an appropriate power level is provided to the battery pack controller 800. For example, the DC/DC controller 870 includes active and/or passive components (e.g., voltage step-down controllers, voltage converters, rectifiers, filters, etc.) to regulate or control the power received to the battery pack controller 800. The battery pack controller 800 may be powered by the hybrid supercapacitor 875 when the one or more battery cell(s) 860 are below a discharge voltage threshold, when the battery pack 700 is in a low-power operating mode (such as a sleep mode or a shipping mode), or the like.

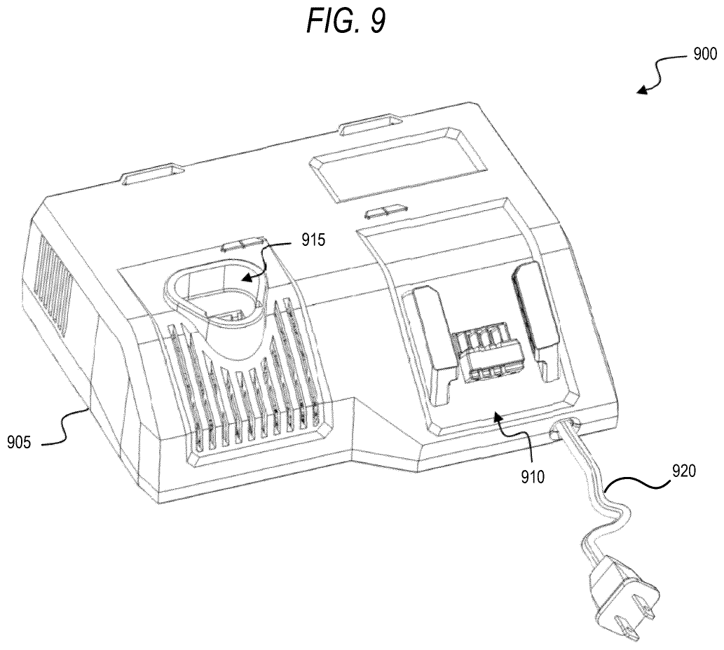

FIG. 9 illustrates a battery pack charger 900. The battery pack charger 900 includes a housing 905 and interface portions 910, 915 for connecting the battery pack charger 900 to one or more battery packs (e.g., battery pack 700). The battery pack charger 900 also includes a power cable 920 for coupling to an AC power source.

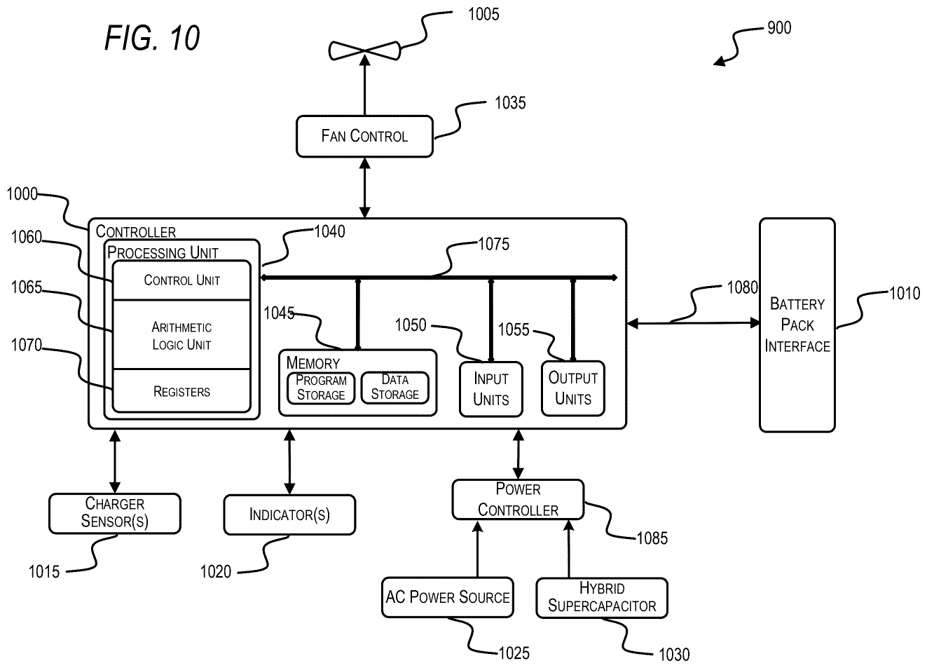

FIG. 10 illustrates a control system for the battery pack charger 900. The control system includes a charger controller 1000. The charger controller 1000 is electrically and/or communicatively connected to a variety of modules or components of the battery pack charger 900. For example, the illustrated charger controller 1000 is electrically connected to a fan 1005, a battery pack interface 1010 (e.g., interface portions 910, 915), one or more charger sensors or charger sensing circuits 1015 (e.g., voltage sensors, current sensors, temperature sensors, etc.), one or more indicators 1020, a fan control module or circuit 1035, an AC power source 1025, and a hybrid supercapacitor 1030. The charger controller 1000 includes combinations of hardware and software that are operable to, among other things, control the operation of the battery pack charger 900, determine a temperature of a heatsink, activate the indicators 1020 (e.g., one or more LEDs), etc.

The charger controller 1000 includes a plurality of electrical and electronic components that provide power, operational control, and protection to the components and modules within the charger controller 1000 and/or battery pack charger 900. For example, the charger controller 1000 includes, among other things, a processing unit 1040 (e.g., a microprocessor, a microcontroller, or another suitable programmable device), a memory 1045, input units 1050, and output units 1055. The processing unit 1040 includes, among other things, a control unit 1060, an ALU 1065, and a plurality of registers 1070 (shown as a group of registers in FIG. 10), and is implemented using a known computer architecture (e.g., a modified Harvard architecture, a von Neumann architecture, etc.). The processing unit 1040, the memory 1045, the input units 1050, and the output units 1055, as well as the various modules or circuits connected to the controller 1000, are connected by one or more control and/or data buses (e.g., common bus 1075). The control and/or data buses are shown generally in FIG. 10 for illustrative purposes. The use of one or more control and/or data buses for the interconnection between and communication among the various modules, circuits, and components would be known to a person skilled in the art in view of the invention described herein.

The memory 1045 is a non-transitory computer-readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 1040 is connected to the memory 1045 and executes software instructions that are capable of being stored in a RAM of the memory 1045 (e.g., during execution), a ROM of the memory 1045 (e.g., on a generally permanent basis), or another non-transitory computer-readable medium such as another memory or a disc. Software included in the implementation of the battery pack charger 900 can be stored in the memory 1045 of the charger controller 1000. The software includes, for example, firmware, one or more applications, program data, filters, rules, one or more program modules, and other executable instructions. The charger controller 1000 is configured to retrieve from the memory 1045 and execute, among other things, instructions related to the control processes and methods described herein. In other constructions, the charger controller 1000 includes additional, fewer, or different components.

The battery pack interface 1010 includes a combination of mechanical components (e.g., rails, grooves, latches, etc.) and electrical components (e.g., one or more terminals) configured to and operable for interfacing (e.g., mechanically, electrically, and communicatively connecting) the battery pack charger 900 with a battery pack (e.g., battery pack 700). For example, the battery pack interface 1010 is configured to receive power via a power line between the AC power source 1025 and the battery pack interface 1010. The battery pack interface 1010 is also configured to communicatively connect to the charger controller 1000 via a communications line 1080.

The charger controller 1000 is configured to determine whether a fault condition of the battery pack charger 900 is present and generate one or more control signals related to the fault condition. For example, the charger sensing circuits 1015 (or charger sensors) include one or more current sensors, one or more temperature sensors, one or more voltage sensors, etc. The charger controller 1000 is configured to detect an over current condition (e.g., when charging the battery pack 700), an over temperature condition, etc. If the charger controller 1000 detects one or more fault conditions of the battery pack charger 900 or determines that a fault condition of the battery pack charger 900 no longer exists, the charger controller 1000 is configured to provide information and/or control signals to another component of the battery pack charger 900 (e.g., the battery pack interface 1010, etc.)

In some embodiments, the battery pack charger 900 includes a hybrid supercapacitor 1030. A power controller 1085 controls whether the charger controller 1000 receives power from an AC power source 1025 or from the hybrid supercapacitor 1030. For example, as described in more detail below, the charger controller 1000 may control the power controller 1085 to switch power input from AC power source 1025 to the hybrid supercapacitor 1030, or vice versa, based on a whether the charger controller 1000 is receiving power from the AC power source 1025. The power controller 1085 includes active and/or passive components (e.g., voltage step-down controllers, voltage converters, rectifiers, filters, etc.) to regulate or control the power received from the AC power source 1025 and the hybrid supercapacitor 1030. In some embodiments, the charger controller 1000 is powered by the hybrid supercapacitor 1030 when the battery pack charger 900 is a low-power operating mode, such as a shipping mode, a sleep mode, or the like.

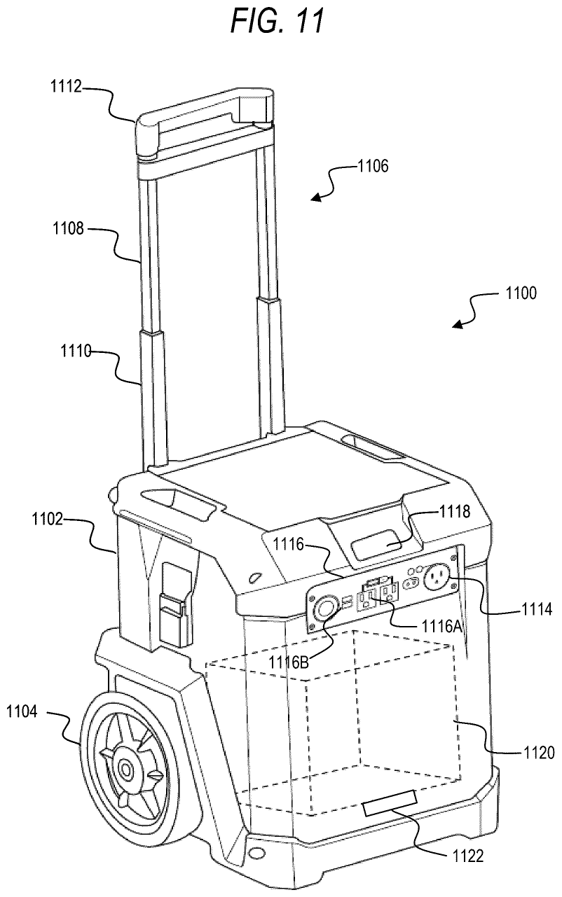

FIG. 11 illustrates a portable power supply device or power supply 1100. The power supply 1100 includes, among other things, a housing 1102. In some embodiments, the housing 1102 includes one or more wheels 1104 and a handle assembly 1106. In the illustrated embodiment, the handle assembly 1106 is a telescoping handle movable between an extended position and a collapsed position. The handle assembly 1106 includes an inner tube 1108 and an outer tube 1110. The inner tube 1108 fits inside the outer tube 1110 and is slidable relative to the outer tube 1110. The inner tube 1108 is coupled to a horizontal holding member 1112. In some embodiments, the handle assembly 1106 further includes a locking mechanism to prevent inner tube 1108 from moving relative to the outer tube 1110 by accident. The locking mechanism may include notches, sliding catch pins, or another suitable locking mechanism to inhibit the inner tube 1108 from sliding relative to the outer tube 1110 when the handle assembly 1106 is in the extended position and/or in the collapsed position. In practice, a user holds the holding member 1112 and pulls upward to extend the handle assembly 1106. The inner tube 1108 slides relative to the outer tube 1110 until the handle assembly 1106 locks in the extended position. The user may then pull and direct the power supply 1100 by the handle assembly 1106 to a desired location. The wheels 1104 of the power supply 1100 facilitate such movement.

The housing 1102 of the power supply 1100 further includes a power input unit 1114, a power output unit 1116, and a display 1118. In the illustrated embodiment, the power input unit 1114 includes multiple electrical connection interfaces configured to receive power from an external power source. In some embodiments, the external power source is a DC power source. For example, the DC power source may be one or more photovoltaic cells (e.g., a solar panel), an electric vehicle (EV) charging station, or any other DC power source. In some embodiments, the external power source is an AC power source. For example, the AC power source may be a conventional wall outlet, such as a 120 V outlet or a 240 V outlet, found in North America. As another example, the AC power source may be a conventional wall outlet, such as a 220V outlet or 230V outlet, found outside of North America. In some embodiments, the power input unit 1114 is replaced by or additionally includes a cable configured to plug into a conventional wall outlet. In some embodiments, the power input unit 1114 further includes one or more devices, such as antennas or induction coils, configured to wirelessly receive power from an external power source. The power received by the power input unit 1114 may be used to charge a core battery (e.g., a power supply battery core), or internal power source 1120, disposed within the housing 1102 of the power supply 1100.

The power received by the power input unit 1114 may also be used to provide power to one or more devices connected to the power output unit 1116. The power output unit 1116 includes one or more power outlets. In the illustrated embodiment, the power output unit 1116 includes a plurality of AC power outlets 1116A and DC power outlets 1116B. It should be understood that the number of power outlets included in the power output unit 1116 is not limited to the power outlets illustrated in FIG. 11. For example, in some embodiments of the power supply 1100, the power output unit 1116 may include more or fewer power outlets than the power outlets included in the illustrated embodiment of the power supply 1100.

In some embodiments, the power output unit 1116 is configured to provide power output by the internal power source 1120 to one or more peripheral devices. In some embodiments, the power output unit 1116 is configured to provide power provided by an external power source directly to one or more peripheral devices. The one or more peripheral devices may be a smartphone, a tablet computer, a laptop computer, a portable music player, a power tool, a power tool battery pack, a power tool battery pack charger, or the like. The peripheral devices may be configured to receive DC and/or AC power from the power output unit 116. In some embodiments, the power supply 1100 includes a hybrid supercapacitor 1122 in addition to the internal power source 1120. The power output unit 1116 may selectively provide one or more peripheral devices with power from the hybrid supercapacitor 1122 in place of, or in addition to, the internal power source 1120. In some instances, the power output unit 1116 controls charging of the hybrid supercapacitor 1122 with power from the internal power source 1120.

In some embodiments, the DC power outlets 1116B include one or more receptacles for receiving and charging power tool battery packs. In such embodiments, power tool battery packs received by, or connected to, the battery pack receptacles 1116B are charged with power output by the internal power source 1120 and/or power received directly from the external power source and/or power provided by the hybrid supercapacitor 1122. In some embodiments, power tool battery packs connected to the battery pack receptacles 1116B are used to provide power to the internal power source 1120 and/or the hybrid supercapacitor 1122 and/or one or more peripheral devices connected to outlets of the power output unit 1116. In some embodiments, the power output unit 1116 includes tool-specific power outlets. For example, the power output unit may include a DC power outlet used for powering a welding tool.

While particular examples of power tool devices have been provided (e.g., the power tool 100, the battery pack 700, the battery pack charger 900, and the power supply 1100), the hybrid supercapacitors described herein may be implemented in other types of power tool devices including, but not limited to, light devices, heating or heated devices (e.g., heated gear), power inverters, hand tools, laser levels, nailers, rotary hammers, plumbing equipment, portable power supplies, outdoor power equipment, radios, headphones, inflation devices, vacuums, fans, and other powered devices.

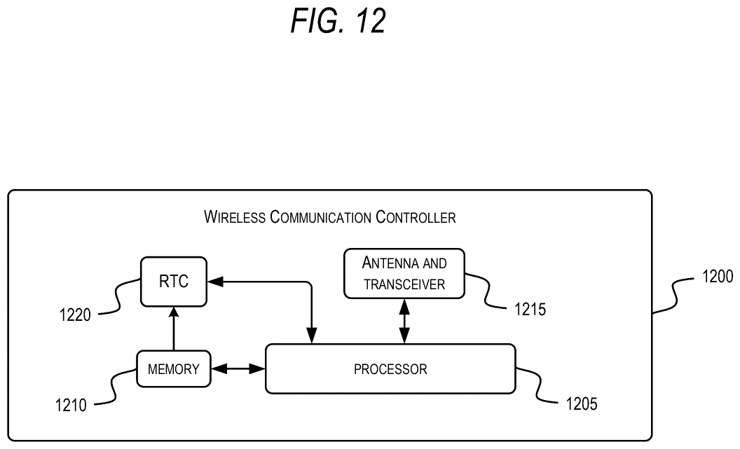

In some embodiments, any of the proposed power tool devices may include a wireless communication controller coupled to their respective controllers for communicating over a wireless network. FIG. 12 illustrates an example wireless communication controller 1200. As shown in FIG. 12, the wireless communication controller 1200 includes a processor 1205, a memory 1210, an antenna and transceiver 1215, and a real-time clock (RTC) 1220. The wireless communication controller 1200 enables a power tool device to communicate with an external device 1305 (see, e.g., FIG. 13). The radio antenna and transceiver 1215 operate together and send and receive wireless messages to and from the external device 1305 and the processor 1205. The memory 1210 can store instructions to be implemented by the processor 1205 and/or may store data related to communications between the power tool device and the external device 1305. For example, the processor 1205 associated with the wireless communication controller 1200 buffers incoming and/or outgoing data, communicates with the power tool device controller, and determines the communication protocol and/or settings to use in wireless communications. The communication via the wireless communication controller 1200 can be encrypted to protect the data exchanged between the power tool device and the external device 1305 from third parties.

In the illustrated embodiment, the wireless communication controller 1200 is a Bluetooth® controller. The Bluetooth® controller communicates with the external device 1305 employing the Bluetooth® protocol. Therefore, in the illustrated embodiment, the external device 1305 and the power tool device are within a communication range (i.e., in proximity) of each other while they exchange data. In other embodiments, the wireless communication controller 1200 communicates using other protocols (e.g., Wi-Fi, ZigBee, a proprietary protocol, etc.) over different types of wireless networks. For example, the wireless communication controller 1200 may be configured to communicate via Wi-Fi through a wide area network such as the Internet or a local area network, or to communicate through a piconet (e.g., using infrared or NFC communications).

In some embodiments, the network is a cellular network, such as, for example, a Global System for Mobile Communications (“GSM”) network, a General Packet Radio Service (“GPRS”) network, a Code Division Multiple Access (“CDMA”) network, an Evolution-Data Optimized (“EV-DO”) network, an Enhanced Data Rates for GSM Evolution (“EDGE”) network, a 3GSM network, a 4GSM network, a 4G LTE network, 5G New Radio, a Digital Enhanced Cordless Telecommunications (“DECT”) network, a Digital AMPS (“IS-136/TDMA”) network, or an Integrated Digital Enhanced Network (“iDEN”) network, etc.

The wireless communication controller 1200 is configured to receive data from the power tool device controller and relay the information to the external device 1305 via the antenna and transceiver 1215. In a similar manner, the wireless communication controller 1200 is configured to receive information (e.g., configuration and programming information) from the external device 1305 via the antenna and transceiver 1215 and relay the information to the power tool device controller.

FIG. 13 illustrates a communication system 1300. The communication system 1300 includes at least one power tool device 100 (illustrated as power tool 100) and the external device 1305. Each power tool device 100 and the external device 1305 can communicate wirelessly while they are within a communication range of each other. Each power tool device 100 may communicate power tool device status, power tool device operation statistics, power tool device identification, power tool device sensor data, stored power tool device usage information, power tool device maintenance information, and the like.

The external device 1305 is, for example, a smart phone (as illustrated), a laptop computer, a tablet computer, a personal digital assistant (PDA), or another electronic device capable of communicating wirelessly with the power tool device 100 and providing a user interface. The external device 1305 provides the user interface and allows a user to access and interact with the power tool device 100. The external device 1305 can receive user inputs to determine operational parameters, enable or disable features (such as a low-power operating mode), and the like. The user interface of the external device 1305 provides an easy-to-use interface for the user to control and customize operation of the power tool device 100. The external device 1305, therefore, grants the user access to tool operational data of the power tool device 100, and provides a user interface such that the user can interact with the controller of the power tool device 100.

In addition, as shown in FIG. 13, the external device 1305 can also share the tool operational data obtained from the power tool device 100 with a remote server 1325 connected through a network 1315. The remote server 1325 may be used to store the tool operational data obtained from the external device 1305, provide additional functionality and services to the user, or a combination thereof. In some embodiments, storing the information on the remote server 1325 allows a user to access the information from a plurality of different locations. In some embodiments, the remote server 1325 collects information from various users regarding their power tool devices and provide statistics or statistical measures to the user based on information obtained from the different power tools. For example, the remote server 1325 may provide statistics regarding the experienced efficiency of the power tool device 100, typical usage of the power tool device 100, and other relevant characteristics and/or measures of the power tool device 100. The network 1315 may include various networking elements (routers 1310, hubs, switches, cellular towers 1320, wired connections, wireless connections, etc.) for connecting to, for example, the Internet, a cellular data network, a local network, or a combination thereof as previously described. In some embodiments, the power tool device 100 is configured to communicate directly with the server 1325 through an additional wireless interface or with the same wireless interface that the power tool device 100 uses to communicate with the external device 1305.

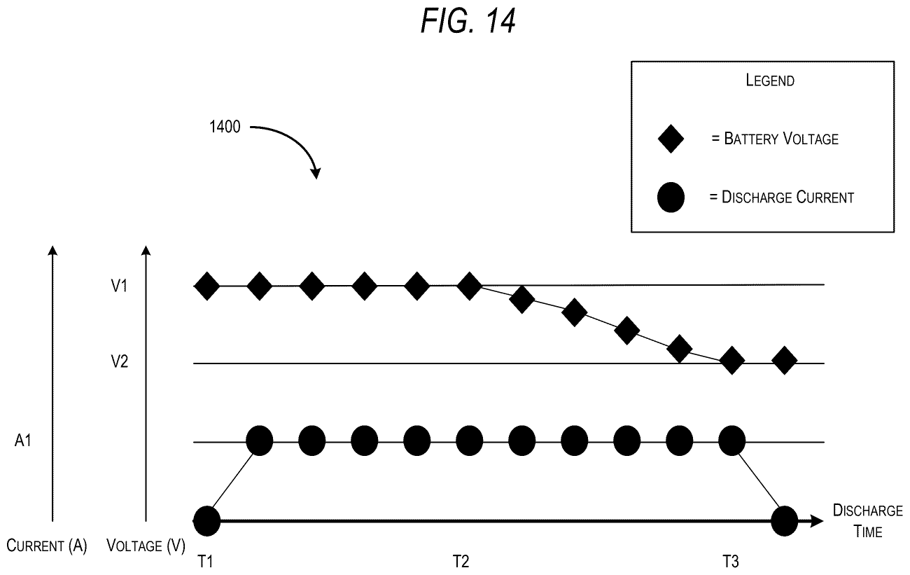

As previously stated, a hybrid supercapacitor (e.g., hybrid supercapacitor 275, 875, 1030, 1122) may be integrated within the various disclosed power tool devices. The hybrid supercapacitor combines structures of both batteries (e.g., lithium-ion batteries) and supercapacitors into a single physical unit having a unique discharging profile. For example, FIG. 14 provides a first discharging profile 1400 for a lithium-ion battery cell. Initially, at time T1, the lithium-ion battery cell is fully charged at a first voltage V1. As the lithium-ion battery cell discharges, the voltage initially is maintained at first voltage V1 (from time T1 to time T2). During discharge, the current is maintained at a first current value A1. However, from time T2 to time T3, the voltage of the lithium-ion battery cell drops from the first voltage V1 to a second voltage V2. As seen in the first discharging profile 1400, the second voltage V2 is greater than 0. Accordingly, the lithium-ion battery cell does not fully discharge.

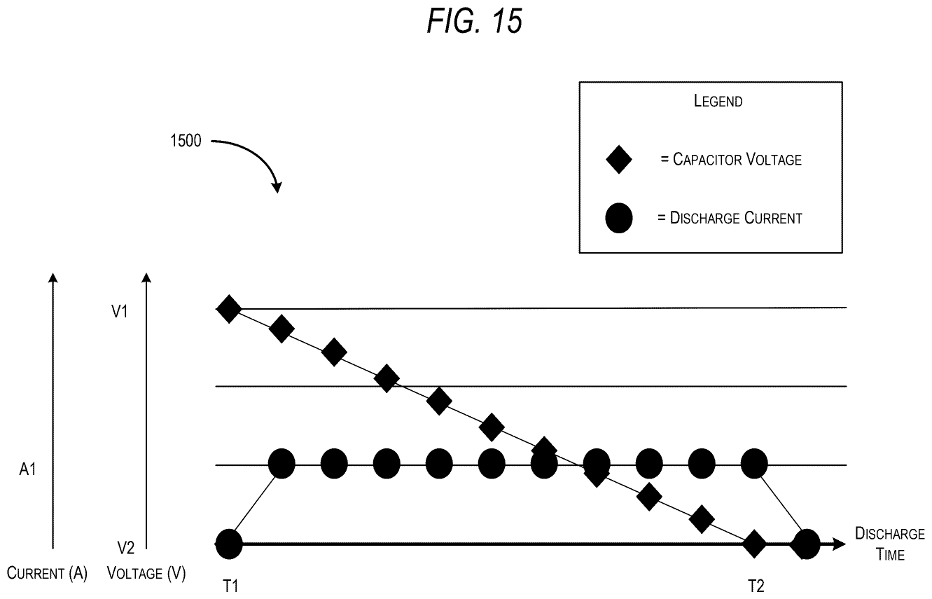

FIG. 15 provides a second discharging profile 1500 for a supercapacitor. Initially, at time T1, the supercapacitor is fully charged at a first voltage V1. As the supercapacitor discharges, the voltage of the supercapacitor linearly decreases from the first voltage V1 to second voltage V2 (from time T1 to time T2). During discharge, the current is maintained at a first current value A1. Unlike the lithium-ion battery cell, the supercapacitor fully discharges to a voltage value of 0 (the second voltage V2).

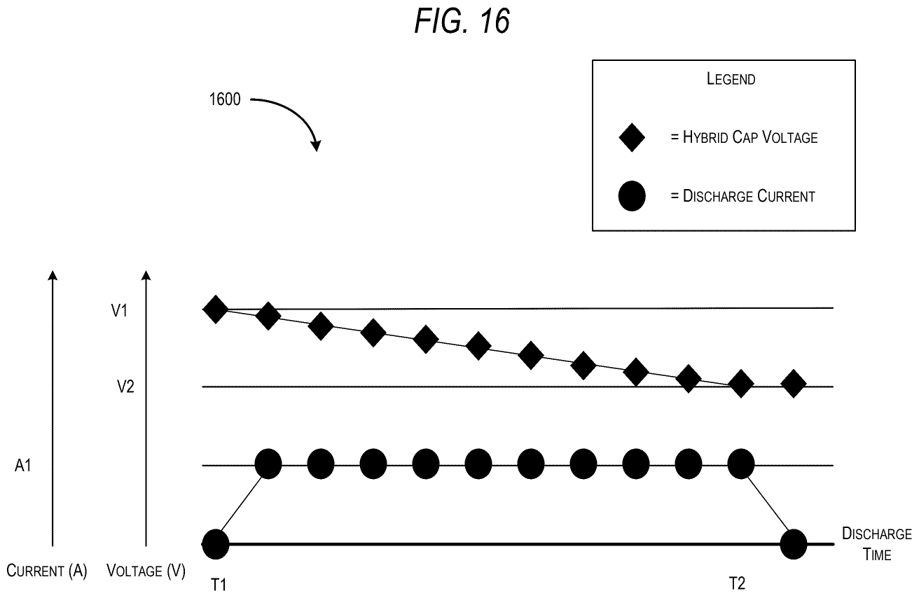

The hybrid supercapacitor has a discharge profile including characteristics of both the lithium-ion battery cell and the supercapacitor. FIG. 16 provides a third discharging profile 1600 for a hybrid supercapacitor. Initially, at time T1, the hybrid supercapacitor is fully charged at a first voltage V1. As the hybrid supercapacitor discharges, the voltage of the hybrid supercapacitor decreases linearly from the first voltage VI to a second voltage V2 (from time T1 to time T2). During discharge, the current is maintained at a first current value A1. Unlike the supercapacitor, the hybrid supercapacitor does not full discharge, and instead discharges only to the second voltage that is greater than 0.

Hybrid supercapacitors are energy sources that merge the chemistry of batteries with the characteristics of supercapacitors within a single housing. As one example, hybrid supercapacitors may include a lithium-ion-doped anode (e.g., a lithium-ion-doped graphite anode) and a cathode (e.g., an activated carbon cathode). This provides for a lower charge movement depth compared to lithium-ion battery cells. Additionally, hybrid supercapacitors have a high cycle-life count (e.g., greater than 500,000 charge and discharge cycles) and fast responsiveness to high discharge rates. Metal oxides are not used in hybrid supercapacitors, and therefore they provide little risk of fire or thermal runaway.

In some embodiments, hybrid supercapacitors have an operating voltage between approximately 3.5 V to 4.5 V and have an operating current between 0.1 A to 2.7 A. In some embodiments, the operating current of the hybrid supercapacitor is between 1.1 A to 15.3 A. Stored energy capacity ratings of hybrid supercapacitors may range from approximately 40 mWh to approximately 300 mWh.

While embodiments described herein primarily refer to a singular hybrid supercapacitor, in some embodiments, the hybrid supercapacitor is a chain or a plurality of hybrid supercapacitors. The plurality of hybrid supercapacitors may be connected in series, in parallel, or a combination thereof to achieve the desired current and voltage output. For example, while a singular hybrid supercapacitor may have an operating voltage of approximately 4.0 V, a plurality of hybrid supercapacitors may be configured to have an operating voltage output of up to approximately 120 V. Additionally, in some embodiments, hybrid ultracapacitors (e.g., capacitors with capacitance values greater than supercapacitors) are used instead of or in addition to the hybrid supercapacitors described herein.

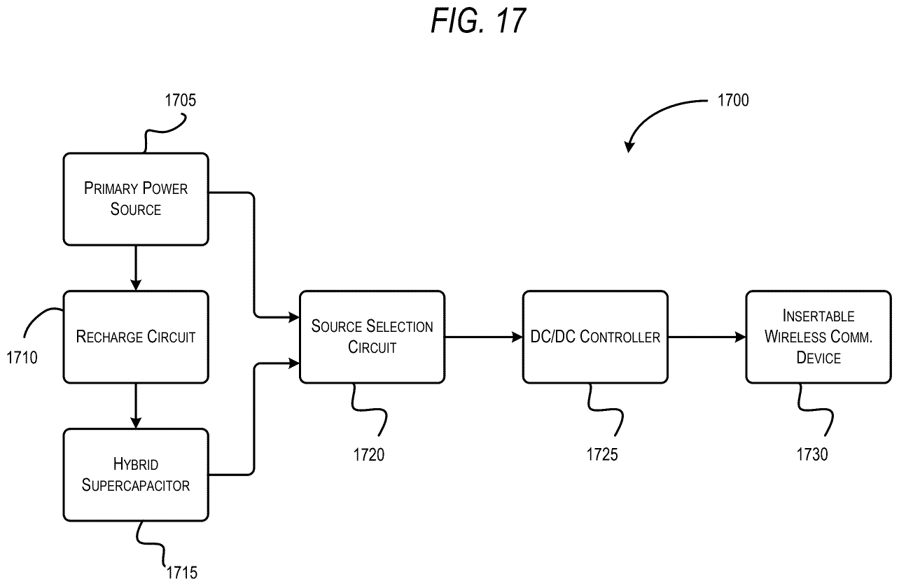

FIG. 17 illustrates a block diagram for a discharging circuit 1700 that discharges to a circuit of a power tool device, such as an insertable wireless communication device 1730. Components within the discharging circuit 1700 may be included in a controller of a power tool device, such as the power tool controller 200, the battery pack controller 800, and/or the charger controller 1000. The insertable wireless communication device 1730 may be, for example, the insertable wireless communication device 280 shown in FIGS. 2-6.

The discharging circuit 1700 includes a source selection circuit 1720 that selects between a primary power source 1705 (e.g., the battery pack 300, the battery cells 860, the AC power source 1025, the internal power source 1120) and a hybrid supercapacitor 1715 (e.g., the hybrid supercapacitor 275, the hybrid supercapacitor 875, the hybrid supercapacitor 1030, the hybrid supercapacitor 1122). Selection between the primary power source 1705 and the hybrid supercapacitor 1715 may be based on a charge voltage of the primary power source 1705 or an operating mode of the respective power tool device, as described in more detail below. In some instances, the discharging circuit 1700 selects both the primary power source 1705 and the hybrid supercapacitor 1715 such that the hybrid supercapacitor 1715 supplements power provided by the primary power source 1705.

The discharge current from the primary power source 1705 and/or the hybrid supercapacitor 1715 is provided to a DC/DC controller 1725. The DC/DC controller 1725 may be included in, for example, the power input unit 260, the DC/DC controller 870, and/or the power controller 1085. The DC/DC controller 1725 controls discharge of the primary power source 1705 and/or the hybrid supercapacitor 1715 such that a desired discharge power is provided to downstream components, such as the insertable wireless communication device 1730. In some embodiments, the DC/DC controller controls discharge of the primary power source 1705 and/or the hybrid supercapacitor 1715 to maintain a desired discharge profile.

In some embodiments, the discharging circuit 1700 includes a recharge circuit 1710. The recharge circuit 1710 is configured to charge the hybrid supercapacitor 1715 using power from the primary power source 1705. In some embodiments, the recharge circuit 1710 only provides charging power to the primary power source 1705 when the primary power source 1705 has a sufficient charge voltage and is not being utilized by the source selection circuit 1720.

In some embodiments, the discharging circuit 1700 discharges current from the primary power source 1705 and/or the hybrid supercapacitor 1715 to a circuit other than the insertable wireless communication device 1730, such as to a communication circuit, a Human-Machine Interface (HMI) circuit, or another discharge load. Additionally, multiple circuits may be configured to receive power from the primary power source 1705 and/or the hybrid supercapacitor 1715 at a given time. For example, to save on power usage, the hybrid supercapacitor 1715 may be controlled to maintain power to a controller (such as controller 200) and to a communication circuit, while other components of the power tool device do not receive power.

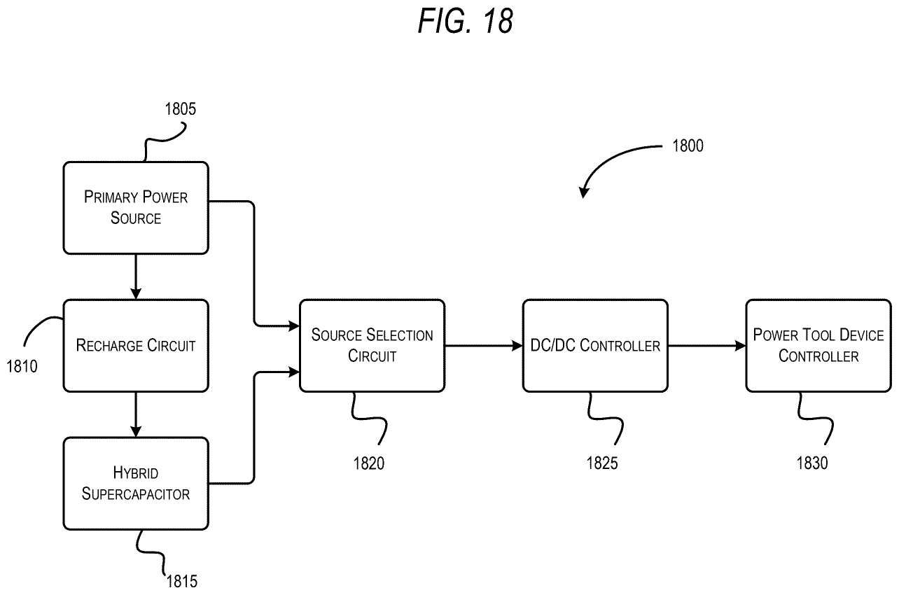

As another example, FIG. 18 illustrates a block diagram for a discharging circuit 1800 that discharges to a power tool device controller 1830. The power tool device controller 1830 may be, for example, the power tool controller 200, the battery pack controller 800, or the charger controller 1000. The discharging circuit 1800 is substantially similar to the discharging circuit 1700 of FIG. 17, and includes a primary power source 1805, a hybrid supercapacitor 1815, a recharge circuit 1810, a source selection circuit 1820, a DC/DC controller 1825, and a power tool device controller 1830. However, instead of discharging to the insertable wireless communication device 1730, the source selection circuit 1820 selects the primary power source 1805, the hybrid supercapacitor 1815, or a combination thereof to discharge to the power tool device controller 1830.

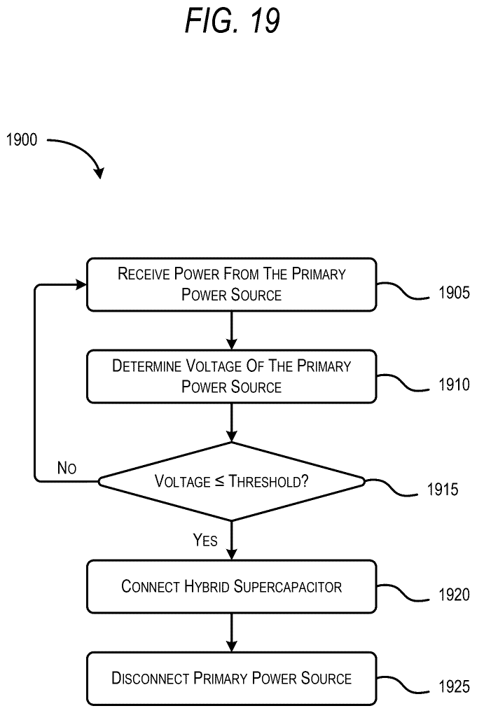

FIG. 19 illustrates a method 1900 for selecting between a primary power source and a hybrid supercapacitor. The method 1900 may be performed by the power tool device controller 1830 (e.g., the power tool controller 200, the battery pack controller 800, the charger controller 1000, etc.). While the method 1900 primarily refers to the power tool device controller 1830 receiving power from the primary power source 1805 and/or the hybrid supercapacitor 1815 in FIG. 18, in some embodiments, the method 1900 applies to the insertable wireless communication device 1730 receiving power from the primary power source 1705 and/or the hybrid supercapacitor 1715 in FIG. 17.

At block 1905, the power tool device controller 1830 receives power from the primary power source 1805. For example, the source selection circuit 1820 is configured to allow the primary power source 1805 to discharge. At block 1910, the power tool device controller 1830 determines the voltage of the primary power source 1805. As one example and with reference to FIG. 2, the voltage sensor(s) 265 provide a voltage signal to the power tool controller 200 indicative of a voltage provided by the battery pack 300. As another example and with reference to FIG. 8, the battery pack sensors 845 provide a voltage signal to the battery pack controller 800 indicative of a voltage of the one or more battery cells 860.

At block 1915, the power tool device controller 1830 determines whether the voltage of the primary power source 1805 is less than or equal to a first voltage threshold. When the voltage of the primary power source 1805 is greater than the first voltage threshold, the power tool device controller 1830 returns to block 1905. When the voltage of the primary power source 1805 is less than or equal to the first voltage threshold, the power tool device controller 1830 proceeds to block 1920.

At block 1920, the power tool device controller 1830 connects the hybrid supercapacitor 1815 to the power tool device controller 1830 such that the power tool device controller 1830 receives power from the hybrid supercapacitor 1815. For example, the source selection circuit 1820 is controlled to allow the hybrid supercapacitor 1815 to discharge.

At block 1925, the power tool device controller 1830 disconnects the primary power source 1805 from the power tool device controller 1830 such that the power tool device controller 1830 no longer receives power from the primary power source 1805. For example, the source selection circuit 1820 is controlled such that only the hybrid supercapacitor 1815 discharges power to the power tool device controller 1830. Accordingly, even when the primary power source 1805 is discharged below a threshold value, the power tool device controller 1830 continues to receive power. In some embodiments, the primary power source 1805 is not present, and the only power source available to the power tool device controller 1830 is the hybrid supercapacitor 1815.

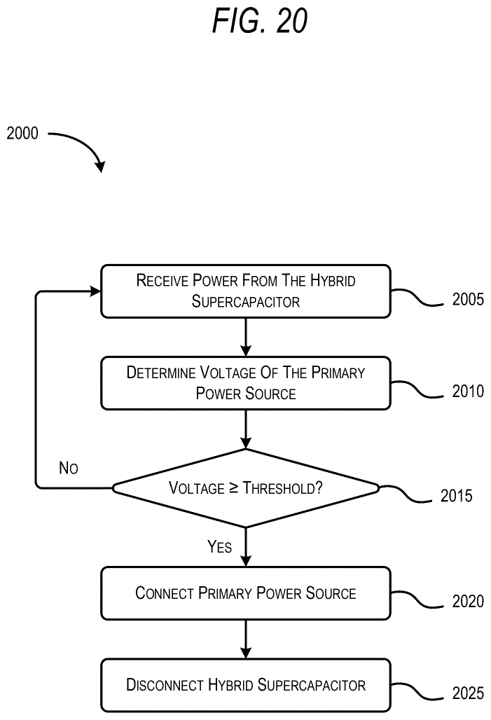

FIG. 20 illustrates another method 2000 for selecting between a primary power source and a hybrid supercapacitor. The method 2000 may be performed by the power tool device controller 1830 (e.g., the power tool controller 200, the battery pack controller 800, the charger controller 1000, etc.). While the method 2000 primarily refers to the power tool device controller 1830 receiving power from the primary power source 1805 and/or the hybrid supercapacitor 1815 in FIG. 18, in some embodiments, the method 2000 applies to the insertable wireless communication device 1730 receiving power from the primary power source 1705 and/or the hybrid supercapacitor 1715 in FIG. 17.

At block 2005, the power tool device controller 1830 receives power from the hybrid supercapacitor 1815. For example, the source selection circuit 1820 is configured to allow the hybrid supercapacitor 1815 to discharge. At block 2010, the power tool device controller 1830 determines the voltage of the primary power source 1805. As one example and with reference to FIG. 2, the voltage sensor(s) 265 provide a voltage signal to the power tool controller 200 indicative of a voltage provided by the battery pack 300. As another example and with reference to FIG. 8, the battery pack sensors 845 provide a voltage signal to the battery pack controller 800 indicative of a voltage of the one or more battery cells 860.

At block 2015, the power tool device controller 1830 determines whether the voltage of the primary power source 1805 is greater than or equal to a second voltage threshold. When the voltage of the primary power source 1805 is less than the second voltage threshold, the power tool device controller 1830 returns to block 2005. When the voltage of the primary power source 1805 is greater than or equal to the second voltage threshold, the power tool device controller 1830 proceeds to block 2020. In some embodiments, the second voltage threshold at block 2015 is greater than the first voltage threshold used in block 1915 in method 1900.

At block 2020, the power tool device controller 1830 connects the primary power source 1805 to the power tool device controller 1830 such that the power tool device controller 1830 receives power from the primary power source 1805. For example, the source selection circuit 1820 is controlled to allow the primary power source 1805 to discharge.

At block 2025, the power tool device controller 1830 disconnects the hybrid supercapacitor 1815 from the power tool device controller 1830 such that the power tool device controller 1830 no longer receives power from the hybrid supercapacitor 1815. For example, the source selection circuit 1820 is controlled such that only the primary power source 1805 discharges power to the power tool device controller 1830. Accordingly, once the primary power source 1805 is charged, the primary power source 1805 is used to power the power tool device controller 1830.

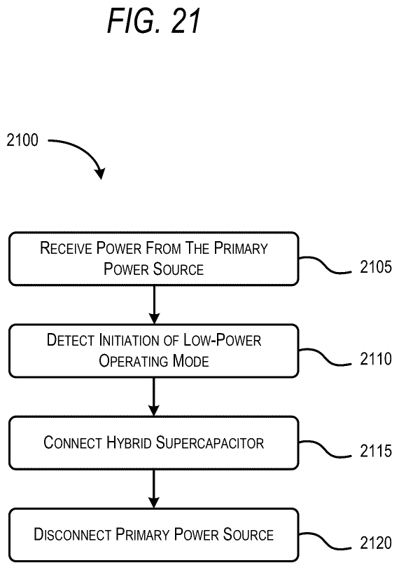

In some embodiments, the hybrid supercapacitor is used to power the power tool device controller 1830 and/or the insertable wireless communication device 1730 when the power tool device is in a low-power operating mode. FIG. 21 illustrates a method 2100 for connecting a hybrid supercapacitor during a low-power operating mode. The method 2100 may be performed by the power tool device controller 1830 (e.g., the power tool controller 200, the battery pack controller 800, the charger controller 1000, etc.). While the method 2100 primarily refers to the power tool device controller 1830 receiving power from the primary power source 1805 and/or the hybrid supercapacitor 1815 in FIG. 18, in some embodiments, the method 2100 applies to the insertable wireless communication device 1730 receiving power from the primary power source 1705 and/or the hybrid supercapacitor 1715 in FIG. 17.

At block 2105, the power tool device controller 1830 receives power from the primary power source 1805. For example, the source selection circuit 1820 is configured to allow the primary power source 1805 to discharge. At block 2110, the power tool device controller 1830 initiates a low-power operating mode for the power tool device. For example, the power tool device may be placed in a sleep mode in response to a lack of charge and/or discharge events. The power tool device may be placed in a shipping mode during shipping of the power tool device from a manufacturing facility to a retail store. In some embodiments, an external device, such as the external device 1305, transmits a signal to the power tool device indicating initiation of a low-power mode.

At block 2115, the power tool device controller 1830 connects, in response to initiation of the low-power operating mode, the hybrid supercapacitor 1815 to the power tool device controller 1830 such that the power tool device controller 1830 receives power from the hybrid supercapacitor 1815. At block 2120, the power tool device controller 1830 disconnects the primary power source 1805 from the power tool device controller 1830 such that the power tool device controller 1830 no longer receives power from the primary power source 1805. For example, the source selection circuit 1820 is controlled such that only the hybrid supercapacitor 1815 discharges power to the power tool device controller 1830. Accordingly, while in a low-power operating mode, the power tool device controller 1830 receives power only from the hybrid supercapacitor 1815, maintaining a voltage of the primary power source 1805 during the low-power operating mode.

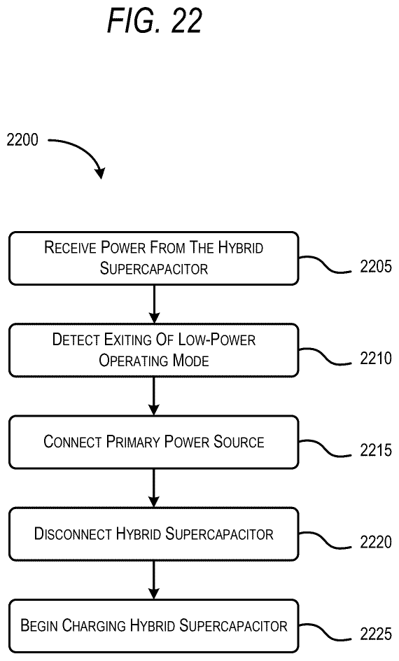

FIG. 22 illustrates a method 2200 for disconnecting a hybrid supercapacitor when exiting a low-power operating mode. The method 2200 may be performed by the power tool device controller 1830 (e.g., the power tool controller 200, the battery pack controller 800, the charger controller 1000, etc.). While the method 2200 primarily refers to the power tool device controller 1830 receiving power from the primary power source 1805 and/or the hybrid supercapacitor 1815 in FIG. 18, in some embodiments, the method 2200 applies to the insertable wireless communication device 1730 receiving power from the primary power source 1705 and/or the hybrid supercapacitor 1715 in FIG. 17.

At block 2205, the power tool device controller 1830 receives power from the hybrid supercapacitor 1815. For example, the source selection circuit 1820 is configured to allow the hybrid supercapacitor 1815 to discharge. At block 2210, the power tool device controller 1830 detects exiting of the low-power operating mode for the power tool device. For example, the power tool device may be removed from a sleep mode in response to a completed charging or charging to above a threshold value. The power tool device may be removed from the sleep mode in response to completion of shipping of the power tool device from a manufacturing facility to a retail store. In some embodiments, an external device, such as the external device 1305, transmits a signal to the power tool device indicating exiting of a low-power mode.

At block 2215, the power tool device controller 1830 connects, in response to exiting of the low-power operating mode, the primary power source 1805 to the power tool device controller 1830 such that the power tool device controller 1830 receives power from the primary power source 1805. At block 2220, the power tool device controller 1830 disconnects the hybrid supercapacitor 1815 from the power tool device controller 1830 such that the power tool device controller 1830 no longer receives power from the hybrid supercapacitor 1815. For example, the source selection circuit 1820 is controlled such that only the primary power source 1805 discharges power to the power tool device controller 1830.

In some instances, the method 2200 includes beginning charging of the hybrid supercapacitor 1815 (at block 2225). For example, once the hybrid supercapacitor 1815 is disconnected from the power tool device controller 1830 by the source selection circuit 1820, the recharge circuit 1810 recharges the hybrid supercapacitor 1815.

In some embodiments, the hybrid supercapacitor 1815 is used to provide power to the power tool device controller 1830 in response to a failure of the primary power source 1805. For example, should a fuse (e.g., an electric fuse) trip on the path of the primary power source 1805, the hybrid supercapacitor 1815 instead powers the respective power tool device until the primary power source 1805 is reset. In some embodiments, the hybrid supercapacitor 1815 is used to provide power to the power tool device controller 1830 when a short circuit condition occurs, a brown-out condition occurs, a high transient load occurs, etc.

### Representative Features

Representative features are set out in the following clauses, which stand alone or may be combined, in any combination, with one or more features disclosed in the text and/or drawings of the specification.
1. A device comprising:
   a primary power source;
   a hybrid supercapacitor; and
   a controller selectively coupled to the primary power source and the hybrid supercapacitor, the controller configured to:
      receive power from the primary power source,
      determine a voltage of the primary power source,
      determine whether the voltage of the primary power source is less than or equal to a voltage threshold, and
      connect, in response to the voltage of the primary power source being less than or equal to the voltage threshold, the hybrid supercapacitor to the controller.
2. The device of clause 1, further comprising:
   a recharge circuit configured to charge the hybrid supercapacitor using the primary power source.
3. The device of any of the preceding clauses, wherein the controller is further configured to:
   provide power from the hybrid supercapacitor to an insertable wireless communication device connected to the controller.
4. The device of any of the preceding clauses, wherein the controller is further configured to:
   disconnect, in response to the voltage of the primary power source being less than or equal to the voltage threshold, the primary power source from the controller.
5. The device of any of the preceding clauses, wherein the controller is further configured to:
   determine whether the voltage of the primary power source is greater than or equal to a second voltage threshold; and
   disconnect, in response to the voltage of the primary power source being greater than or equal to the second voltage threshold, the hybrid supercapacitor.
6. The device of any of the preceding clauses, wherein the hybrid supercapacitor includes a plurality of hybrid supercapacitors connected in series.
7. The device of any of the preceding clauses, wherein the controller is further configured to:
   determine whether a low-power operating mode is initiated;
   connect, in response to the low-power operating mode being initiated, the hybrid supercapacitor to the controller; and
   disconnect, in response to the low-power operating mode being initiated, the primary power source from the controller.
8. The device of any of the preceding clauses, wherein the device is one selected from a group consisting of a power tool, a power tool battery pack, a battery pack charger, a power inverter, and a portable power supply device.
9. The device of any of the preceding clauses, wherein the device is one selected from a group consisting of a light device, a heating device, an outdoor power equipment device, and vacuum.
10. The device of any of the preceding clauses, wherein the primary power source is at least one battery cell.
11. The device of any of the preceding clauses, wherein the primary power source is a power supply battery core.
12. A method for selecting a discharging power source, the method comprising:
   receiving, with a discharge load, power from a primary power source;
   determining, with the controller, a voltage of the primary power source;
   determining, with the controller, whether the voltage of the primary power source is less than or equal to a voltage threshold; and
   connecting, with the controller and in response to the voltage of the primary power source being less than or equal to the voltage threshold, a hybrid supercapacitor to the discharge load.
13. The method of clause 12, further comprising:
   charging, with a recharge circuit, the hybrid supercapacitor using the primary power source.
14. The method of any of clauses 12-13, further comprising:
   providing, with the controller, the power from the hybrid supercapacitor to an insertable wireless communication device connected to the controller.
15. The method of any of clauses 12-14, further comprising:
   disconnecting, with the controller and in response to the voltage of the primary power source being less than or equal to the voltage threshold, the primary power source from the discharge load.
16. The method of any of clauses 12-15, further comprising:
   determining, with the controller, whether the voltage of the primary power source is greater than or equal to a second voltage threshold; and
   disconnecting, with the controller and in response to the voltage of the primary power source being greater than or equal to the second voltage threshold, the hybrid supercapacitor.
17. The method of any of clauses 12-16, further comprising:
   determining, with the controller, whether a low-power operating mode has been initiated;
   connecting, with the controller and in response to the low-power operating mode being initiated, the hybrid supercapacitor to the discharge load; and
   disconnecting, with the controller and in response to the low-power operating mode being initiated, the primary power source from the discharge load.
18. A device comprising:
   a primary power source;
   a hybrid supercapacitor;
   an insertable wireless communication device; and
   a controller selectively coupled to the primary power source and the hybrid supercapacitor, the controller configured to:
      provide power from the primary power source to the insertable wireless communication device;
      determine a voltage of the primary power source;
      determine whether the voltage of the primary power source is less than or equal to a voltage threshold; and
      provide, in response to the voltage of the primary power source being less than or equal to the voltage threshold, power from the hybrid supercapacitor to the insertable wireless communication device.
19. The device of clause 18, wherein the controller is further configured to:
   determine whether the voltage of the primary power source is greater than or equal to a second voltage threshold; and
   provide, in response to the voltage of the primary power source being greater than or equal to the second voltage threshold, power from the primary power source to the insertable wireless communication device.
20. The device of any of clauses 18-19, wherein the controller is further configured to:
   determine whether a low-power operating mode is initiated; and
   provide, in response to the low-power operating mode being initiated, power from the hybrid supercapacitor to the insertable wireless communication device.

Thus, embodiments provided herein describe, among other things, systems and methods for implementing a hybrid supercapacitor within power tool devices. Various features and advantages are set forth in the following claims.

What is claimed is:

1. A device comprising:
a primary power source;
a hybrid supercapacitor; and
a controller selectively coupled to the primary power source and the hybrid supercapacitor, the controller configured to:
receive power from the primary power source,
determine a voltage of the primary power source,
determine whether the voltage of the primary power source is less than or equal to a voltage threshold, and
connect, in response to the voltage of the primary power source being less than or equal to the voltage threshold, the hybrid supercapacitor to the controller.

2. The device of claim 1, further comprising:
a recharge circuit configured to charge the hybrid supercapacitor using the primary power source.

3. The device of claim 1, wherein the controller is further configured to:
provide power from the hybrid supercapacitor to an insertable wireless communication device connected to the controller.

4. The device of claim 1, wherein the controller is further configured to:
disconnect, in response to the voltage of the primary power source being less than or equal to the voltage threshold, the primary power source from the controller.

5. The device of claim 1, wherein the controller is further configured to:
determine whether the voltage of the primary power source is greater than or equal to a second voltage threshold; and
disconnect, in response to the voltage of the primary power source being greater than or equal to the second voltage threshold, the hybrid supercapacitor.

6. The device of claim 1, wherein the hybrid supercapacitor includes a plurality of hybrid supercapacitors connected in series.

7. The device of claim 1, wherein the controller is further configured to:
determine whether a low-power operating mode is initiated;
connect, in response to the low-power operating mode being initiated, the hybrid supercapacitor to the controller; and
disconnect, in response to the low-power operating mode being initiated, the primary power source from the controller.

8. The device of claim 1, wherein the device is one selected from a group consisting of a power tool, a power tool battery pack, a battery pack charger, a power inverter, and a portable power supply device.

9. The device of claim 1, wherein the device is one selected from a group consisting of a light device, a heating device, an outdoor power equipment device, and vacuum.

10. The device of claim 1, wherein the primary power source is at least one battery cell.

11. The device of claim 1, wherein the primary power source is a power supply battery core.

12. A method for selecting a discharging power source, the method comprising:
receiving, with a discharge load, power from a primary power source;
determining, with the controller, a voltage of the primary power source;
determining, with the controller, whether the voltage of the primary power source is less than or equal to a voltage threshold; and
connecting, with the controller and in response to the voltage of the primary power source being less than or equal to the voltage threshold, a hybrid supercapacitor to the discharge load.

13. The method of claim 12, further comprising:
charging, with a recharge circuit, the hybrid supercapacitor using the primary power source.

14. The method of claim 12, further comprising:
providing, with the controller, the power from the hybrid supercapacitor to an insertable wireless communication device connected to the controller.

15. The method of claim 12, further comprising:
disconnecting, with the controller and in response to the voltage of the primary power source being less than or equal to the voltage threshold, the primary power source from the discharge load.

16. The method of claim 12, further comprising:
determining, with the controller, whether the voltage of the primary power source is greater than or equal to a second voltage threshold; and
disconnecting, with the controller and in response to the voltage of the primary power source being greater than or equal to the second voltage threshold, the hybrid supercapacitor.

17. The method of claim 12, further comprising:
determining, with the controller, whether a low-power operating mode has been initiated;
connecting, with the controller and in response to the low-power operating mode being initiated, the hybrid supercapacitor to the discharge load; and
disconnecting, with the controller and in response to the low-power operating mode being initiated, the primary power source from the discharge load.

18. A device comprising:
a primary power source;
a hybrid supercapacitor;
an insertable wireless communication device; and
a controller selectively coupled to the primary power source and the hybrid supercapacitor, the controller configured to:
provide power from the primary power source to the insertable wireless communication device;
determine a voltage of the primary power source;
determine whether the voltage of the primary power source is less than or equal to a voltage threshold; and
provide, in response to the voltage of the primary power source being less than or equal to the voltage threshold, power from the hybrid supercapacitor to the insertable wireless communication device.

19. The device of claim 18, wherein the controller is further configured to:
determine whether the voltage of the primary power source is greater than or equal to a second voltage threshold; and
provide, in response to the voltage of the primary power source being greater than or equal to the second voltage threshold, power from the primary power source to the insertable wireless communication device.

20. The device of claim 18, wherein the controller is further configured to:
determine whether a low-power operating mode is initiated; and
provide, in response to the low-power operating mode being initiated, power from the hybrid supercapacitor to the insertable wireless communication device.
